(19) United States
(12) Patent Application Publication
(10) Pub. No.: US 2014/0174070 A1
(43) Pub. Date: Jun. 26, 2014

(54) LIQUID AND AIR SEPARATOR

(71) Applicant: CATERPILLAR INC., Peoria, IL (US)

(72) Inventors: Isaiah Olateru, Champaign, IL (US); Mark Allott, Mapleton, IL (US); Jeffrey R. Ries, Metamora, IL (US); Lynsey Hart, Brimfield, IL (US)

(73) Assignee: Caterpillar Inc., Peoria, IL (US)

(21) Appl. No.: 13/781,798

(22) Filed: Mar. 1, 2013

Related U.S. Application Data
(60) Provisional application No. 61/739,816, filed on Dec. 20, 2012.

(51) Int. Cl. F15B 21/04

(52) U.S. Cl. CPC F15B 21/044
USPC 60/453; 55/307; 55/434; 55/413; 55/320

(57) ABSTRACT

A liquid and air separator includes a housing having a sloped floor and a domed roof, an adaptor, a spacer, a deflector having a plurality of perforations thereon, and a plurality of breathers, each of the plurality of breathers having a stepped portion.

### RELATED APPLICATION

This application is based upon and claims the benefit of priority from U.S. Provisional Application No. 61/739,816 by Isaiah Olateru et al., filed Dec. 20, 2012, the contents of which are expressly incorporated herein by reference.

### TECHNICAL FIELD

The disclosure relates to vehicles having hydraulic systems, and more particularly to a liquid and air separator for a hydraulic system.

### BACKGROUND

This section is intended to provide a background or context to the invention recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Many vehicles include hydraulic systems for moving a work implement. Hydraulic fluid resides in a hydraulic tank. A pump draws fluid from the tank and pressurizes the fluid, sending the fluid to a valve. When the valve is open, the pressurized fluid moves the work implement. Some hydraulic tanks may be open to the atmosphere to inhibit the buildup of pressure in the tank due to fluid temperature changes and/or atmospheric temperature and pressure changes. A breather, filter or liquid and air separator may be placed over an opening on the tank to inhibit dirt or other contaminants from entering the tank.

An example of an air-breather device can be found in U.S. Pat. No. 4,595,118, issued Jun. 17, 1986, for an “Air-Breather Device for Oil Casing.” The air-breather device described therein includes a cylindrical breather plug deflector attached to the wall of an oil casing and having an end opening into the oil casing and the other end open to the outside of the oil casing. The air-breather device includes a spring-urged cover on one end and a baffle plate.

### SUMMARY

In one embodiment the disclosure is a liquid and air separator having a housing having an exterior portion and an interior portion wherein the interior portion comprises a dome-shaped roof and a sloped floor. The liquid and air separator also has a deflector disposed in the interior portion of the housing and a breather coupled to the housing, the breather being configured to allow air to pass from the atmosphere to the interior of the housing.

In another embodiment the disclosure is a vehicle including a frame, a hydraulic tank coupled to the frame, a hydraulic pump coupled to the frame, the hydraulic pump configured to draw fluid from the hydraulic tank and a work implement coupled to the frame. The vehicle also includes a hydraulic actuator coupled to the work implement and fluidly coupled to the hydraulic pump, the hydraulic actuator being configured to selectively move the work implement. The vehicle further includes a liquid and air separator fluidly coupled to the hydraulic tank, the liquid and air separator having a housing having an exterior portion and an interior portion wherein the interior portion includes a dome-shaped roof and a sloped floor. The liquid and air separator also includes a deflector disposed in the interior portion of the housing and a breather coupled to the housing, the breather being configured to allow air to pass from the atmosphere to the interior of the housing.

Yet another embodiment of the disclosure is a liquid and air separator having a housing having an opening disposed on a bottom portion thereof. The liquid and air separator further includes a deflector disposed in an interior of the housing, and a breather coupled to the housing, the breather being configured to release air from the housing, the breather having a stem including a stepped interior portion wherein the diameter of the stepped interior portion increases from a first end to a second end.

### BRIEF DESCRIPTION OF THE DRAWINGS

FIG. 1 is a side view of a wheel loader.

FIG. 2 is a perspective view of a liquid and air separator.

FIG. 3 is a section view of the liquid and air separator of FIG. 2.

FIG. 4 is an exploded view of the liquid and air separator of FIG. 2.

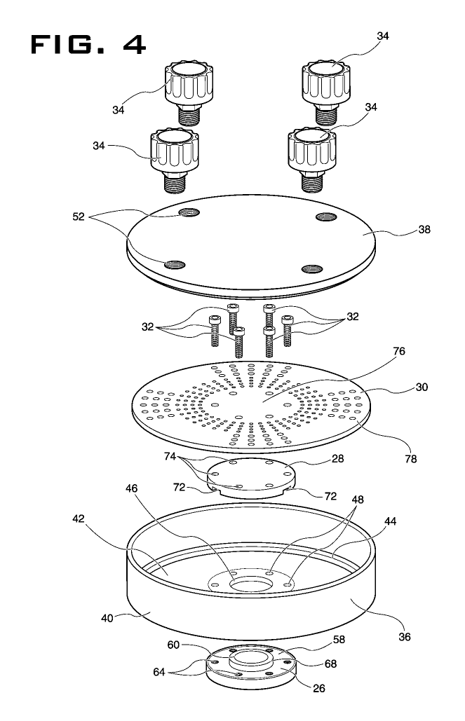

FIG. 5 is a perspective view of a deflector.

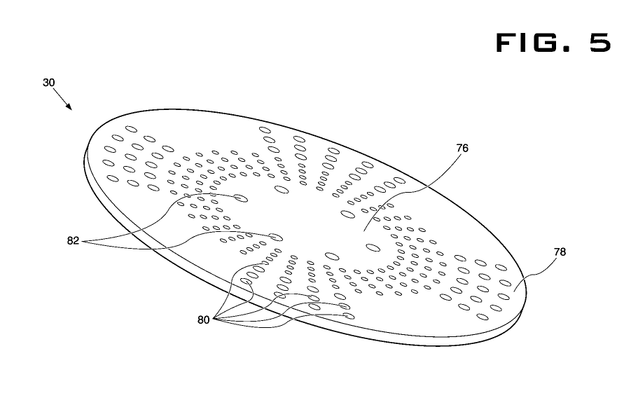

FIG. 6 is a section view of a breather.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

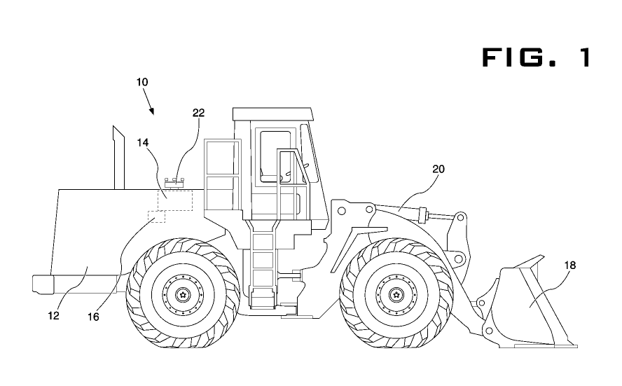

Referring to FIG. 1, a vehicle 10 is shown according to an exemplary embodiment. In the exemplary embodiment the vehicle 10 is a wheel loader, but other types of vehicles such as track-type tractors, motor graders, skid steers, dump trucks, excavators, backhoe loaders, etc. are contemplated. The vehicle 10 includes a frame 12, a hydraulic tank 14 coupled to the frame 12, a hydraulic pump 16 coupled to the frame 12 and a work implement 18 coupled to the frame 12. A hydraulic cylinder 20 is coupled to the work implement 18, the hydraulic cylinder 20 being configured to selectively move the work implement 18. In an alternative embodiment a hydraulic actuator moves the work implement 18. Hydraulic fluid is disposed in the interior of the hydraulic tank 14. The hydraulic pump 16 draws fluid from the hydraulic tank 14 and pressurizes the fluid. One or more fluid lines fluidly connect the hydraulic pump 16 to the hydraulic cylinder 20 to allow the pressurized fluid to enter the hydraulic cylinder 20. One or more fluid lines fluidly connect the hydraulic cylinder 20 to the hydraulic tank 14 to allow fluid to return to the hydraulic tank 14 from the hydraulic cylinder 20.

A liquid and air separator 22 is fluidly connected to the hydraulic tank 14. In some embodiments the liquid and air separator 22 rests on the tank 14. The liquid and air separator 22 includes a housing 24, an adaptor 26, a spacer 28, a deflector 30, a plurality of screws 32 and a plurality of breathers 34. In an alternative embodiment a plurality of bolts, nails or the like may be used in place of the plurality of screws 32. The liquid and air separator 22 may be used on a vehicle 10 as described herein or it may be used on a stationary machine or any hydraulic system.

The housing 24 includes a lower member 36 and an upper member 38. In the illustrated embodiment the upper member 38 is press fit to the lower member 36. In an alternative embodiment the upper member 38 includes threads disposed thereon and corresponding threads are disposed on the lower member 36, allowing the upper member 38 and lower member 36 to be coupled together. In yet another embodiment the upper member 38 may be joined to the lower member 36 by welding or by using an adhesive.

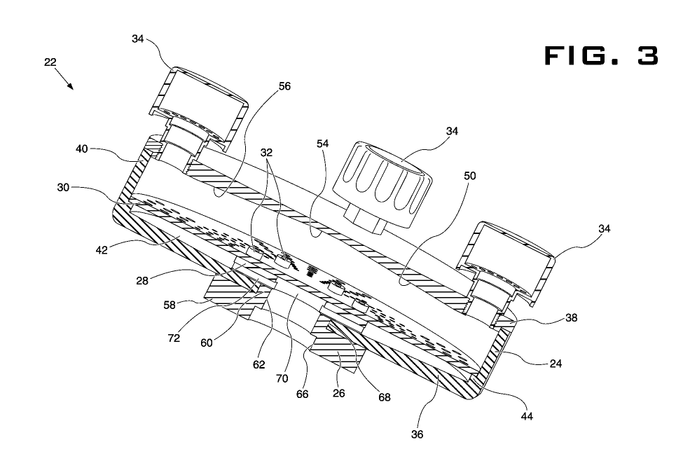

The lower member 36 is approximately in the shape of a cylinder and includes an outer ring 40 and a floor 42. In the illustrated embodiment the outer ring 40 and floor 42 are integral, but in other embodiments they may be separate pieces that are coupled together. The outer ring 40 includes a shelf 44 disposed thereon to allow the deflector 30 to rest on the shelf 44. As best shown in FIG. 3, the floor 42 is continuously sloped from a high point proximal to the outer ring 40 to a low point closest to the center of the floor 42. An opening 46 is disposed in the center of the floor 42. In an alternative embodiment the lowest point of the floor 42 is not closest to the center and the opening 46 is disposed approximately at the lowest point of the floor 42. A plurality of through-holes 48 is disposed on the floor 42 to allow one or more pieces of the liquid and air separator 22 to be coupled to the floor 42.

The upper member 38 is approximately disc-shaped and includes a roof 50 and a plurality of apertures 52 disposed thereon. The roof 50 is dome shaped (as best seen in FIG. 3) such that a center portion 54 of the roof 50 is thinner than an outer circumference portion 56 of the roof 50. As can be seen in FIG. 3, the distance from the center portion 54 of the roof 50 to the deflector 30 is greater than the distance from the outer circumference portion 56 of the roof 50 to the deflector 30. Each aperture 52 of the plurality of apertures 52 is threaded. In the illustrated embodiment four apertures 52 are disposed on the upper member 38, but greater or fewer apertures 52 are contemplated.

The adaptor 26 includes a disc 58 and a ring 60. In the illustrated embodiment the disc 58 and ring 60 are integral, but in an alternative embodiment they may be two separate pieces that are coupled together. A through-hole 62 extends through both the disc 58 and the ring 60. A plurality of openings 64, each of the plurality of openings 64 having threads disposed thereon, is disposed on the disc 58 to receive the plurality of screws 32. In the illustrated embodiment an interior portion 66 of the disc may be coupled to the hydraulic tank 14, a hydraulic line, a pipe or the like using a press-fit. In an alternative embodiment threads may be disposed on the interior portion 66 of the disc 58. An exterior portion 68 of the ring 60 is sized and configured to allow the ring 60 to be coupled to the housing 24 using a press-fit, adhesive, welding, or the like. In an alternative embodiment threads are disposed on the exterior portion 68 of the ring 60 and corresponding threads are disposed on the housing 24 to allow the two pieces to be coupled together.

The spacer 28 is cylindrical and includes a hollow portion 70 disposed in the center of the spacer 28. Passageways 72 are disposed on the spacer 28, the passageways 72 allowing a fluid to pass from the hollow portion 70 to an area outside of the spacer 28. A plurality of through-holes 74 is disposed on the spacer 28 to assist in assembling the liquid and air separator 22. The primary purpose of the spacer 28 is to make the liquid and air separator 22 easier to assemble. In an alternative embodiment the liquid and air separator 22 does not include the spacer 28. In yet another alternative embodiment the spacer 28 is integral to the deflector 30.

The deflector 30 is disc-shaped and includes a center section 76 and an outer section 78. The center section 76 of the deflector 30 is solid. The outer section 78 of the deflector 30 includes a plurality of perforations 80 disposed thereon. In the illustrated embodiment each of the plurality of perforations 80 is circular in shape, but other shapes are contemplated. The deflector 30 is sized and configured to fit snugly into the housing 24 such that a fluid flowing from the floor 42 to the roof 50 must pass through the perforations 80. A plurality of through-holes 82 is disposed on the deflector 30 to aid in assembly of the liquid and air separator 22.

In the illustrated embodiment four breathers 34 are used, although more or less breathers 34 may be used in other embodiments. Each breather 34 is substantially similar to the other breathers 34. The breather 34 includes a stem 84 and a cap 86. In the illustrated embodiment the stem 84 and the cap 86 are integral. In an alternative embodiment the stem 84 and the cap 86 are separate pieces that are coupled together.

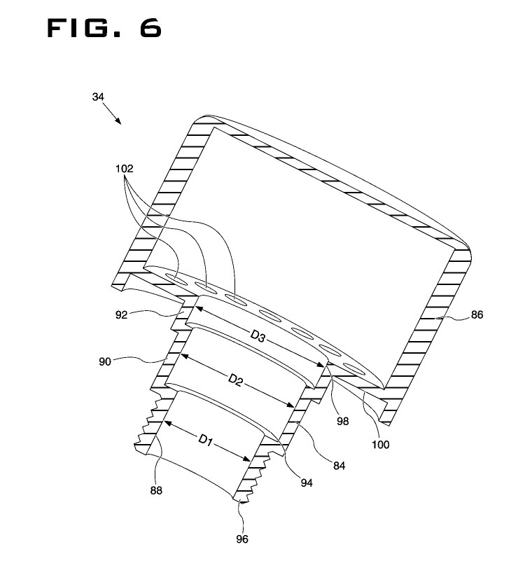

The stem 84 is hollow and includes a first step portion 88, a second step portion 90 and a third step portion 92. The first step portion 88 has threads disposed on the exterior thereof to assist in coupling the breather 34 to the housing 24. As best seen in FIG. 6, the first step portion 88 has a first inner diameter D1. The second step portion 90 has a second inner diameter D2. The third step portion 92 has a third inner diameter D3. The third inner diameter D3 is greater than the second inner diameter D2. The second inner diameter D2 is greater than the first inner diameter D1. The first step portion 88, second step portion 90 and third step portion 92 cooperate to define a stepped interior 94 which increases in diameter from a first end 96 to a second end 98.

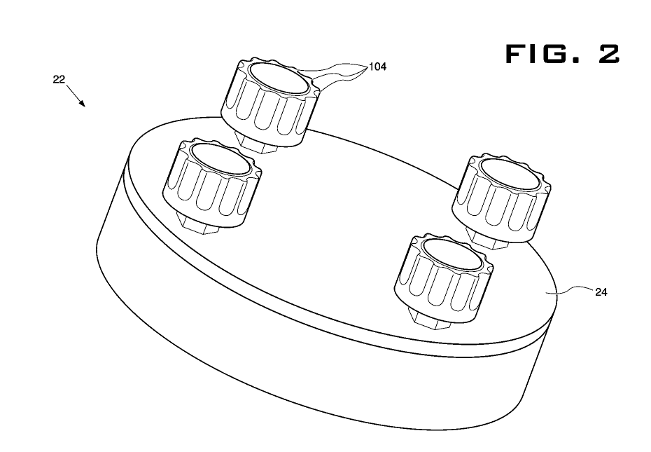

The cap 86 is substantially cylindrical and is hollow. The diameter of the cap 86 is greater than the diameter of the stem 84 such that the cap 86 includes an overhang 100. A plurality of openings 102 is disposed on the overhang 100 to allow a fluid to pass from the interior of the cap 86 to the exterior of the cap 86. In the illustrated embodiment the exterior of the cap 86 includes ridges 104 disposed thereon (best shown in FIG. 2). The ridges 104 assist in heat transfer from the cap 86 to the atmosphere. In addition, the ridges 104 provide a gripping surface that is useful when assembling the breather 34 to the housing 24.

In some embodiments a filter may be disposed in the interior of the housing 24 between the deflector 30 and the breathers 34. In one embodiment the filter is a mesh filter.

The liquid and air separator 22 may be assembled as follows. First, the spacer 28 is placed in the lower member 36 such that the through-holes 74 on the spacer 28 are aligned with the through-holes 48 on the lower member 36. Next, the deflector 30 is placed in the lower member 36 such that the through-holes 82 on the deflector 30 are aligned with the through-holes 74 on the spacer 28. After that each of the plurality of screws 32 is placed through the aligned through-holes 82, 74, 48. Next the adaptor 26 is placed proximal to the lower member 36 and the screws 32 are placed into the openings 64. The screws 32 are then tightened into the openings 64 to couple the deflector 30, spacer 28, lower member 36 and adaptor 26 together. At this point, if the filter is to be used the filter is placed on top of the deflector 30. After that the upper member 38 is coupled to the lower member 36. Finally, the breathers 34 are attached to the upper member 38. At this point the liquid and air separator 22 is assembled and may be coupled to the hydraulic tank 14, hydraulic line, pipe or the like.

### INDUSTRIAL APPLICABILITY

The liquid and air separator 22 may be used with any hydraulic system that is open to the atmosphere. During use, the hydraulic fluid in the hydraulic system may become heated which can result in a higher pressure in the hydraulic tank 14 as compared to atmospheric pressure. Conversely, cooling hydraulic fluid (such as when the hydraulic system is not in use) can result in a lower pressure in the hydraulic tank 14 as compared to atmospheric pressure. It is desirable to keep the pressure inside of the hydraulic tank 14 approximately equal to atmospheric pressure. In order for the pressure inside of the hydraulic tank 14 to be kept approximately equal to atmospheric pressure at times air must enter or exit the hydraulic tank 14. It is common for air inside of the hydraulic tank 14 to be mixed with hydraulic fluid mist due to the movement of the hydraulic fluid. It is desirable to keep the hydraulic fluid inside of the hydraulic tank 14. The liquid and air separator 22 serves to separate liquid, such as hydraulic fluid or oil, from air that is leaving the hydraulic tank 14 so that the liquid is returned to the hydraulic tank 14.

The liquid and air separator 22 separates liquid from air as follows. Air mixed with liquid enters the liquid and air separator 22 through the adaptor 26. The center portion 76 of the deflector 30 inhibits liquid from splashing past the deflector 30. In addition, the center portion 76 of the deflector 30 serves to attract a portion of liquid from the air mixed with liquid. After hitting the deflector 30 the air mixed with liquid passes through the passageways 72 on the spacer 28 and is passed to the area between the floor 42 and the deflector 30. The perforations 80 on the deflector 30 allow the air mixed with liquid to pass through while catching a portion of the liquid, thus removing some of the liquid from the air mixed with liquid. Next, if installed, the air mixed with liquid passes through the filter and the filter serves to remove some liquid from the air mixed with liquid. The air mixed with liquid then passes into the breathers 34. As the air mixed with liquid passes from the first step portion 88 to the second step portion 90 and then the third step portion 92, the velocity of the air mixed with liquid slows down due to the increasing diameters of the step portions 88, 90, 92. This slowing of the air mixed with liquid results in some of the liquid being removed from the air mixed with liquid and being left on the stem 84. At this point a significant portion, in some cases approaching nearly all, of the liquid has been removed from the air mixed with liquid. The air mixed with liquid then exits through the openings 102 on the overhang 100 of the breather 34.

The housing 24 includes a dome shaped roof 50 and a sloping floor 42 as has been described above. The dome shaped roof 50 assists in controlling dispersion of air mixed with liquid that flows up out of the hydraulic tank 14. The sloped floor 42 encourages liquid that has been removed from air mixed with liquid to return to the hydraulic tank 14.

In the illustrated embodiment four breathers 34 are used. It has been found that using multiple smaller breathers 34 results in reduced flow rates as compared to using one larger breather 34. Reduced flow rates have been found to reduce the amount of liquid leaving the breathers 34.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A liquid and air separator comprising:
a housing having an exterior portion and an interior portion wherein the interior portion comprises:
a dome-shaped roof; and
a sloped floor;
a deflector disposed in the interior portion of the housing; and
a breather coupled to the housing, the breather being configured to allow air to pass from the atmosphere to the interior of the housing.

2. The liquid and air separator of claim 1 wherein the breather includes a cap and a stem, the interior of the stem having a first diameter and a second diameter, the first diameter being smaller than the second diameter.

3. The liquid and air separator of claim 2 wherein the interior of the stem has a third diameter, the second diameter being smaller than the third diameter.

4. The liquid and air separator of claim 3 wherein the breather includes a plurality of openings disposed on an overhang of the cap.

5. The liquid and air separator of claim 1 wherein the deflector includes a solid center section and an outer section, the outer section having a plurality of perforations disposed thereon.

6. The liquid and air separator of claim 1 wherein the sloped floor has an opening disposed in the center of the sloped floor.

7. The liquid and air separator of claim 1 wherein the housing includes a shelf, the shelf supporting a portion of the deflector.

8. A vehicle comprising:
a frame;
a hydraulic tank coupled to the frame;
a hydraulic pump coupled to the frame, the hydraulic pump configured to draw fluid from the hydraulic tank;
a work implement coupled to the frame;
a hydraulic actuator coupled to the work implement and fluidly coupled to the hydraulic pump, the hydraulic actuator being configured to selectively move the work implement; and
a liquid and air separator fluidly coupled to the hydraulic tank, the liquid and air separator comprising:
a housing having an exterior portion and an interior portion wherein the interior portion comprises:
a dome-shaped roof; and
a sloped floor;
a deflector disposed in the interior portion of the housing; and
a breather coupled to the housing, the breather being configured to allow air to pass from the atmosphere to the interior of the housing.

9. The vehicle of claim 8 wherein the breather includes a cap and a stem, the interior of the stem having a first diameter and a second diameter, the first diameter being smaller than the second diameter.

10. The vehicle of claim 9 wherein the interior of the stem has a third diameter, the second diameter being smaller than the third diameter.

11. The vehicle of claim 10 wherein the breather includes a plurality of openings disposed on an overhang of the cap.

12. The vehicle of claim 8 wherein the deflector includes a solid center section and an outer section, the outer section having a plurality of perforations disposed thereon.

13. The vehicle of claim 8 wherein the sloped floor has an opening disposed in the center of the sloped floor.

14. The vehicle of claim 8 further comprising a mesh filter disposed in the interior portion of the housing, the mesh filter being disposed between the deflector and the breather.

15. A liquid and air separator comprising:
a housing having an opening disposed on a bottom portion thereof;
a deflector disposed in an interior of the housing; and
a breather coupled to the housing, the breather being configured to release air from the housing, the breather having a stem including a stepped interior portion wherein the diameter of the stepped interior portion increases from a first end to a second end.

16. The liquid and air separator of claim 15 further comprising a mesh filter disposed between the deflector and the breather.

17. The liquid and air separator of claim 15 wherein the deflector includes a solid center section and an outer section, the outer section having a plurality of perforations disposed thereon.

18. The liquid and air separator of claim 15 wherein the housing includes an interior portion having a dome-shaped roof.

19. The liquid and air separator of claim 18 wherein the interior portion has a sloped floor.

20. The liquid and air separator of claim 15, the breather further comprising a cap having a plurality of openings disposed on an overhang of the cap.
